(19) United States
(12) Patent Application Publication
(10) Pub. No.: US 2019/0031168 A1
(43) Pub. Date: Jan. 31, 2019

(54) NEGATIVE-PRESSURE TYPE BOOSTER DEVICE

(71) Applicant: ADVICS CO., LTD., Kariya-shi, Aichi-ken (JP)

(72) Inventor: Yoji INOUE, Toyoake-shi, Aichi-ken (JP)

(73) Assignee: ADVICS CO., LTD., Kariya-shi, Aichi-ken (JP)

(21) Appl. No.: 16/072,053

(22) PCT Filed: Sep. 29, 2016
(86) PCT No.: PCT/JP2016/078951

§ 371 Date: Jul. 23, 2018

(30) Foreign Application Priority Data
Jan. 25, 2016 (JP) 2016-011216

(51) Int. Cl. B60T 13/573; B60T 13/569

(52) U.S. Cl. CPC B60T 13/573; B60T 8/3275; B60T 13/569

(57) ABSTRACT

This negative-pressure type booster device improves operation feeling for a driver at the time of a sudden braking operation. A valve body is provided with a flange part which extends in the radially outward direction from a front section of the valve body, and a plate is provided with a locking part which comes into contact with the flange part so as to restrict a movement in the axially forward direction relative to the valve body.

### TECHNICAL FIELD

The present invention relates to a negative-pressure type booster device.

### BACKGROUND ART

As one form of the negative-pressure type booster device, one disclosed in Patent Literature 1 is known. As illustrated in FIG. 1 of Patent Literature 1, the negative-pressure type booster device is formed of a hollow booster shell 2 (housing), an annular booster piston 13 (plate), and an annular diaphragm 14, and is provided with a movable partition wall which partitions the interior of the booster shell 2 into a front negative-pressure chamber 15 and a rear working chamber 16 (variable pressure chamber). The diaphragm 14 is such that an outer peripheral side bead 14a is interposed between joining parts of shell half bodies 2a and 2b, and an inner peripheral side bead 14b is attached to a tapered main body 17a of a valve body 17 using a ring-shaped stopper 18 together with an inner peripheral edge 13a of the booster piston 13.

### CITATIONS LIST

### Patent Literature

Patent Literature 1: Japanese Unexamined Patent Publication No. H09-058456

### SUMMARY OF INVENTION

### Technical Problems

In the above-described negative-pressure type booster device, when a brake operating member is operated, the booster piston 13 moves forward integrally by operating force. At that time, when a negative pressure in the negative-pressure chamber 15 is high and a differential pressure between the negative-pressure chamber 15 and the working chamber 16 is relatively large, atmospheric air is smoothly introduced into the working chamber 16. As a result, forward pressing force due to the large differential pressure between the negative-pressure chamber 15 and the working chamber 16 is maintained to be large, and the forward movement of the booster piston 13 is assisted.

However, there is a case in which the negative pressure (absolute value) in the negative-pressure chamber 15 is low and the differential pressure between the negative-pressure chamber 15 and the working chamber 16 is relatively small. In this case, especially when the brake is suddenly operated (at the time of the sudden braking operation), the differential pressure between the negative-pressure chamber 15 and the working chamber 16 disappears during the operation. As a result, the forward pressing force due to the differential pressure between the negative-pressure chamber 15 and the working chamber 16 disappears and the forward movement of the booster piston 13 is not assisted. Also, there is a case in which the pressure in the negative-pressure chamber 15 becomes higher than the pressure in the working chamber 16 by further braking operation. In this case, the difference in pressure between the negative-pressure chamber 15 and the working chamber 16 is pushed in by the operating force of a driver. From the description above, in the conventional negative-pressure type booster device, there is a possibility that operation feeling for the driver is impaired at the time of the sudden braking operation.

Accordingly, the present invention is achieved to solve the above-described problems, and an object thereof is to improve the operation feeling for the driver at the time of the sudden braking operation in the negative-pressure type booster device.

### Solutions to Problems

In order to solve the above-described problem, the invention according to claim 1 is a negative-pressure type booster device provided with a hollow housing, a movable partition wall formed of an annular plate and an annular diaphragm for partitioning the interior of the housing into a front negative-pressure chamber and a rear variable pressure chamber, a cylindrical valve body provided so as to be movable forward and rearward with respect to the housing and provided so as to be movable forward and rearward with respect to the movable partition wall in the housing, an air valve provided in a shaft hole formed in the valve body and movable forward and rearward in an axial direction of the shaft hole with respect to the valve body and integrally moves with an input member, and a valve mechanism provided with a negative-pressure valve for allowing the negative-pressure chamber to communicate with the variable pressure chamber and blocking the communication in accordance with the forward and rearward movement of the air valve with respect to the valve body and an atmospheric valve for allowing the variable pressure chamber to communicate with atmospheric air and blocking the communication, in which the valve body is provided with a flange part extending in a radially outward direction from a front part of the valve body, and the plate is provided with a locking part which comes into contact with the flange part so as to restrict movement in an axially forward direction relative to the valve body.

### Advantageous Effects of Invention

According to this, when a brake operating member is operated, although an input member moves forward and the valve body moves forward by the operation, the plate may move separately from the movement of the valve body. That is, the valve body may move forward before the plate moves. As a result, it is possible to inhibit a pressure in the negative-pressure chamber from increasing to approach a pressure in the variable pressure chamber to be eventually higher than the pressure in the variable pressure chamber due to the integral movement of the plate with the valve body at the time of the sudden braking operation. Therefore, it becomes possible to inhibit operation resistance of a driver due to the increase in the pressure in the negative-pressure chamber, so that it is possible to improve operation feeling for the driver at the time of sudden braking operation.

### BRIEF DESCRIPTION OF DRAWINGS

FIG. 1 is a cross-sectional view illustrating a first embodiment of a negative-pressure type booster device according to the present invention.

FIG. 2 is an enlarged cross-sectional view mainly illustrating a valve body and a movable partition wall illustrated in FIG. 1, illustrating a brake pedal non-operation state.

FIG. 3 is an enlarged cross-sectional view mainly illustrating the valve body and the movable partition wall illustrated in FIG. 1, illustrating a brake pedal sudden depressed state.

FIG. 4 is a cross-sectional view illustrating a second embodiment of a negative-pressure type booster device according to the present invention.

### DESCRIPTION OF EMBODIMENTS

### First Embodiment

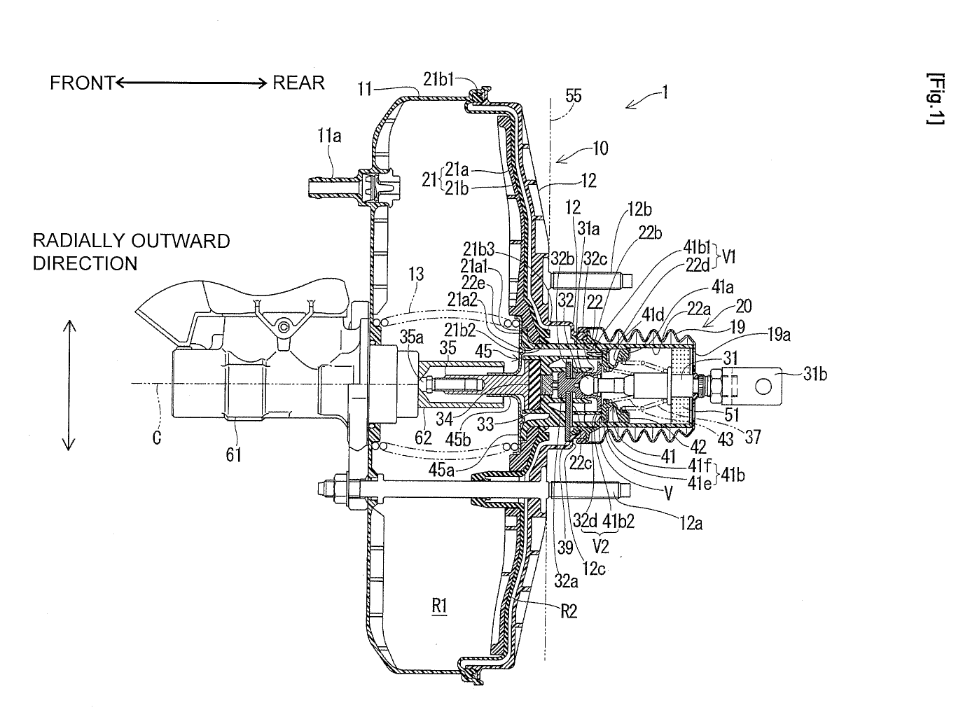

Hereinafter, a negative-pressure type booster device according to a first embodiment of the present invention is described with reference to the drawings. As illustrated in FIG. 1, in a negative-pressure type booster device 1, a power piston 20 provided with a movable partition wall 21 and a valve body 22 is assembled to a housing 10 so as to be movable in a front-rear direction (horizontal direction in FIG. 1), and the interior of the housing 10 is partitioned by the movable partition wall 21 into a front negative-pressure chamber R1 (constant pressure chamber) and a rear variable pressure chamber R2.

The housing 10 is provided with a front shell 11 and a rear shell 12. The front shell 11 is provided with a negative-pressure introduction pipe 11a for allowing the negative-pressure chamber R1 to constantly communicate with a negative-pressure source (for example, an intake manifold of an engine not illustrated). The housing 10 is fixed to a stationary member, that is, an attached member 55 by a plurality of attaching bolts 12a and 12b which airtightly penetrates the rear shell 12, and is configured to support a brake master cylinder 61 by a plurality of attaching bolts 12a (tie rod bolts) which airtightly penetrates the front shell 11.

The brake master cylinder 61 is well known and is airtightly assembled to the front shell 11 at a rear end of a cylinder main body (not illustrated). A piston 62 of the brake master cylinder 61 protrudes rearward from the cylinder main body to enter the negative-pressure chamber R1 and is configured to be pushed forward by a front end 35a of an output shaft 35 to be described later.

The movable partition wall 21 of the power piston 20 formed of an annular plate 21a and an annular diaphragm 21b is installed so as to be movable in the front-rear direction (axial direction of the power piston 20) (movable forward and rearward) in the housing 10. The front-rear direction of the housing 10 is an extending direction of a center line C of the housing 10 (a center line (axial line) of the valve body 22, a plunger 32, or the output shaft 35).

An inner peripheral surface of an inner peripheral end on the valve body 22 side of the plate 21a is in sliding contact with an outer peripheral surface of the valve body 22. A locking part 21a1 is provided on the inner peripheral end of the plate 21a. The locking part 21a1 may come into contact with a flange part 22e (to be described later) of the valve body 22. The locking part 21a1 comes into contact with the flange part 22e, thereby restricting a movement of the plate 21a in the axially forward direction relative to the valve body 22.

A guide part 21a2 is provided on the inner peripheral end on the valve body 22 side of the plate 21a. The guide part 21a2 is in sliding contact with the outer peripheral surface of the valve body 22 and extends in the axial direction of the plate 21a. A length (thickness) in the axial direction of a sliding contact part which is in sliding contact with the outer peripheral surface of the valve body 22 is of a predetermined amount. This predetermined amount is set to a value such that a center line of the plate 21a does not incline with respect to the center line of the valve body 22. Also, the predetermined amount is set to a value which maintains slidability of the plate 21a with respect to the outer peripheral surface of the valve body 22. The guide part 21a2 guides the plate 21a in the axial direction relative to the valve body 22.

The diaphragm 21b is airtightly pinched by the housing 10 by an annular outer peripheral bead part 21b1 formed on an outer peripheral end thereof. In addition, the diaphragm 21b is provided with an annular seal part 21b2 on an inner peripheral end thereof. The seal part 21b2 being a seal member for maintaining airtightness with the outer peripheral surface of the valve body 22 is formed, for example, into a lip shape. The lip shape of the seal part 21b2 is configured such that the seal part 21b2 is pressed against the outer peripheral surface of the valve body 22 by an internal pressure in the variable pressure chamber R2 when the pressure in the variable pressure chamber R2 is higher than the pressure in the negative-pressure chamber R1. Meanwhile, when the pressure in the variable pressure chamber R2 is lower than the pressure in the negative-pressure chamber R1, there is a case in which gas in the negative-pressure chamber R1 flows into the variable pressure chamber R2 passing between the seal part 21b2 and the outer peripheral surface of the valve body 22.

The diaphragm 21b is provided with an annular first stopper 21b3 provided on a rear surface of the inner peripheral end thereof. The first stopper 21b3 may come into contact with a contacted part provided on the valve body 22 side. In this embodiment, the contacted part is a key member 39. When the first stopper 21b3 comes into contact with the key member 39, this restricts the movement of the diaphragm 21b and eventually the plate 21a in an axially rearward direction relative to the valve body 22. Meanwhile, although the plate 21a is not fixed to the diaphragm 21b in this embodiment, the plate 21a may also be fixed to the diaphragm 21b with an adhesive or the like.

The valve body 22 of the power piston 20 being a hollow body made of resin is airtightly assembled to the rear shell 12 of the housing 10 at an intermediate part formed into a cylindrical shape so as to be movable in the front-rear direction (axial direction of the power piston 20). The valve body 22 is provided so as to be movable forward and rearward in an inner peripheral part of the movable partition wall 21 in the housing 10. In other words, the valve body 22 is assembled to the housing 10 so as to be relatively movable. The valve body 22 is biased rearward by a return spring 13 interposed between the valve body 22 and the front shell 11 of the housing 10. Meanwhile, a part protruding outside the housing 10 of the valve body 22 is covered to be protected by a boot 19 having a plurality of ventilation holes 19a at a rear end thereof.

Also, a stepped shaft hole 22a penetrating in the front-rear direction is formed in the valve body 22. In the valve body 22, a pair of negative-pressure communication paths 22b (only one of them is illustrated in FIG. 1) communicating with an intermediate step part of the shaft hole 22a at a rear end thereof and communicating with the negative-pressure chamber R1 at a front end thereof is formed. In the valve body 22, a key attachment hole 22c which is substantially orthogonal to a front part of the shaft hole 22a and through which the key member 39 may be inserted from an outer periphery is formed. The valve body 22 is provided with the flange part 22e extending in a radially outward direction from a front end (front part) of the valve body 22. A rear end face of the flange part 22e may come into contact with a front end face of the locking part 21a1 of the plate 21a.

To the shaft hole 22a described above, an input shaft 31 and the plunger 32 (corresponding to an air valve) are coaxially assembled, and a valve mechanism V and a filter 51 are coaxially assembled. Also, to the shaft hole 22a described above, a connecting member 33, a reaction member 34, and the output shaft (output member) 35 are coaxially assembled in front of the plunger 32.

The input shaft 31 may move forward and rearward with respect to the valve body 22, and is articulated to a receiving connecting part 32c of the plunger 32 at a spherical tip end 31a. The input shaft 31 connected to a brake pedal via a yoke (both are not illustrated) at a rear end threaded part 31b is configured to receive pedal force acting on the brake pedal (brake operating member) forward as an input. The input shaft 31 is an input member for inputting the pedal force to the brake master cylinder 61. Also, the input shaft 31 is engaged with the return spring 37 at a rear end flange part thereof, and is biased rearward by the return spring 37. Also, the plunger 32 connected to the input shaft 31 is biased rearward by the return spring 37.

The plunger 32 may come into contact with a central part of a rear surface of the reaction member 34 at a tip end 32a thereof via the connecting member 33. The tip end 32a is a part which partially receives reaction force of an output from the reaction member 34 via the connecting member 33. The plunger 32 may be engaged with the key member 39 at an annular groove 32b formed at an intermediate part thereof. Also, an annular atmospheric valve seat 32d in the valve mechanism V is formed at a rear end of the plunger 32.

The reaction member 34, the central part of the rear surface of which may be deformed to swell rearward, is assembled to a front end of the valve body 22 in a state in which an entire front surface thereof is engaged (comes into contact) with a rear surface of a rear end of the output shaft 35. The reaction member 34 may come into contact with the front surface of the connecting member 33 at a part of the rear surface thereof and comes into contact with an annular front end face of the valve body 22. A rear end of the connecting member 33 may come into contact with a front surface of the tip end 32a of the plunger 32.

The output shaft 35 is assembled in a front end of the shaft hole 22a of the valve body 22 together with the reaction member 34 so as to be movable in the front-rear direction. The output shaft 35 comes into contact with an engaging part (concaved part) of the piston 62 in the brake master cylinder 61 at the tip end 35a so as to be able to push and transmits the reaction force received from the piston 62 of the brake master cylinder 61 to the reaction member 34 at the time of braking operation.

A retainer 45 is provided on a front surface of the valve body 22. The retainer 45 is formed of an annular disc part 45a and a cylindrical part 45b provided so as to protrude forward from an inner periphery of the annular disc part 45a. A rear surface of the annular disc part 45a may come into contact with the front end of the valve body 22. A rear end of the return spring 13 comes into contact with an outer peripheral part of the annular disc part 45a, and the retainer 45 is biased rearward by the return spring 13. The output shaft 35 is inserted through the cylindrical part 45b.

The key member 39 may come into contact with and separate from the valve body 22, the plunger 32, and the housing 10 (contact part 12c), and defines a movement amount in the axial direction of the plunger 32 with respect to the valve body 22. The key member 39 has a function of defining the movement in the front-rear direction of the plunger 32 with respect to the valve body 22 of the power piston 20 and a function of defining a rearward movement limit position (rearward return position of the valve body 22) of the power piston 20 with respect to the housing 10. The key member 39 is assembled to the valve body 22 and the plunger 32 so as to be relatively movable in the axial direction of the power piston 20 by a required amount.

The valve mechanism V is provided with a negative-pressure valve V1 for allowing the negative-pressure chamber R1 to communicate with the variable pressure chamber R2 or blocking the communication in accordance with the movement forward and rearward of the plunger 32 with respect to the valve body 22, and an atmospheric valve V2 for allowing the variable pressure chamber R2 to communicate with the atmospheric air or blocking the communication. The valve mechanism V is provided with a negative-pressure valve seat 22d provided on the valve body 22. The negative-pressure valve seat 22d is formed integrally with a rear end of the negative-pressure communication path 22b in the valve body 22. The negative-pressure valve seat 22d is formed into an arc shape or a circular shape. The valve mechanism V is provided with an atmospheric valve seat 32d provided on the plunger 32. The atmospheric valve seat 32d is integrally formed into an annular shape at the rear end of the plunger 32. The valve mechanism V is provided with a valve element 41. The valve element 41 is provided with a negative-pressure valve part 41b1 forming the negative-pressure valve V1 together with the negative-pressure valve seat 22d and an atmospheric valve part 41b2 forming the atmospheric valve V2 together with the atmospheric valve seat 32d and is formed of an elastic material (for example, a rubber material or a silicon material (having elasticity)).

A movable part 41b is connected to an attachment part 41a via a connecting part 41d and is movable relative to the attachment part 41a. The movable part 41b includes the negative-pressure valve part 41b1 which may be seated on/separated from the negative-pressure valve seat 22d forming the negative-pressure valve V1 capable of allowing the negative-pressure chamber R1 to communicate with the variable pressure chamber R2 or blocking the communication together with the negative-pressure valve seat 22d. The movable part 41b includes the annular atmospheric valve part 41b2 which may be seated on/separated from the atmospheric valve seat 32d forming the atmospheric valve V2 capable of allowing the variable pressure chamber R2 to communicate with the atmospheric air or blocking the communication together with the atmospheric valve seat 32d. The movable part 41b is biased forward by a compression spring 43. Also, the movable part 41b is formed of an elastic movable part 41e made of an elastic material and a metal movable part 41f formed into an annular plate shape made of a metal material fixed to a rear surface of the elastic movable part 41e. The elastic movable part 41e is integrally connected to the connecting part 41. The movable part 41b (and eventually the valve element 41) is integrally formed by vulcanization molding or the like.

According to the configuration of the valve mechanism V described above, the variable pressure chamber R2 may communicate with the negative-pressure chamber R1 or the atmospheric air in accordance with the movement of the input shaft 31 and the plunger 32 in the front-rear direction with respect to the valve body 22. That is, when the input shaft 31 and the plunger 32 move forward from an original position (return position) in FIG. 1 with respect to the valve body 22, the negative-pressure valve part 41b1 is seated on the negative-pressure valve seat 22d, and the atmospheric valve seat 32d is separated from the atmospheric valve part 41b2, the communication of the variable pressure chamber R2 with the negative-pressure chamber R1 is blocked and the variable pressure chamber R2 communicates with the atmospheric air. At that time, the atmospheric air flows into the variable pressure chamber R2 through the ventilation hole 19a of the boot 19, the filter 51, the interior of the valve element 41, a gap between the atmospheric valve seat 32d and the atmospheric valve part 41b2, the communication path provided in the valve body 22 and the like.

Also, in a state in which the input shaft 31 and the plunger 32 return to the return position (original position) with respect to the valve body 22, the atmospheric valve seat 32d is seated on the atmospheric valve part 41b2, and the negative-pressure valve part 41b1 is separated from the negative-pressure valve seat 22d (that is, a state in which the atmospheric valve V2 closes, the communication between the variable pressure chamber R2 and the atmospheric air is blocked, and the negative-pressure valve V1 opens and the negative-pressure chamber R1 and the variable pressure chamber R2 communicate with each other), the communication of the variable pressure chamber R2 with the atmospheric air is blocked and the variable pressure chamber R2 communicates with the negative-pressure chamber R1. At that time, air is sucked to flow from the variable pressure chamber R2 to the negative-pressure chamber R1 through the communication path provided in the valve body 22, the gap between the negative-pressure valve part 41b1 and the negative-pressure valve seat 22d, the negative-pressure communication path 22b and the like.

Next, operation of the negative-pressure type booster device 1 configured as described above is described with reference to FIGS. 1 to 3.

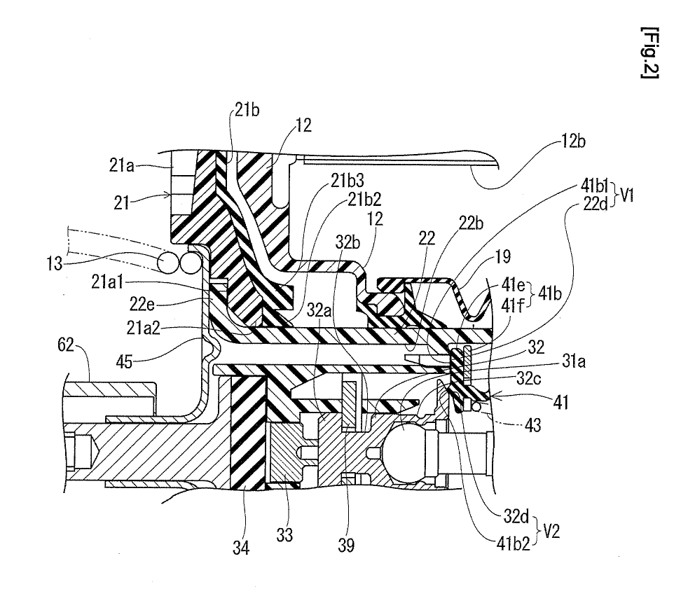

Brake Pedal Non-Operation State (FIGS. 1 and 2)

FIGS. 1 and 2 illustrate a non-operation state. As described above, the input shaft 31 and the plunger 32 which are biased rearward are located in the original position with respect to the valve body 22. At that time, the atmospheric valve V2 closes and the negative-pressure valve V1 opens. Furthermore, the key member 39 is interposed between the rear shell 12 and the valve body 22 biased rearward by the return spring 13. Rear surfaces on upper and lower ends of the key member 39 come into contact with the contact part 12c of the rear shell 12. The contact part 12c is formed into an annular shape of an elastic material (for example, a rubber material or the like). A front surface of a central part in a vertical direction of the key member 39 comes into contact with a front face of an inner wall of the key attachment hole 22c. Furthermore, since the plunger 32 is biased rearward, a front surface of the key member 39 comes into contact with a front surface of the annular groove 32b of the plunger 32 and is positioned to be fixed.

Brake Pedal Normal Depression State

When the brake pedal is depressed at a normal speed and the valve body 22 moves forward, the input shaft 31 and the plunger 32 move forward from the original position (return position) in FIG. 1 with respect to the valve body 22, the atmospheric valve V2 opens, and the negative-pressure valve V1 closes. At that time, the pressure in the negative-pressure chamber R1 is a negative pressure, and when the pressure in the negative-pressure chamber R1 is sufficiently lower than the pressure in the variable pressure chamber R2 and a differential pressure between the negative-pressure chamber R1 and the variable pressure chamber R2 is relatively large, forward pressing force with respect to the plate 21a due to the large differential pressure between the negative-pressure chamber R1 and the variable pressure chamber R2 is maintained to be large and the forward movement of the plate 21a and eventually the valve body 22 is assisted. That is, the plate 21a (and the diaphragm 21b) is moved forward integrally with the valve body 22. Meanwhile, the normal speed is a speed within a predetermined range and is a depression speed at which the atmospheric air is smoothly introduced into the variable pressure chamber R2. The normal speed is affected by a negative pressure of a negative-pressure source and a cross-sectional area and a length of an atmospheric introduction path.

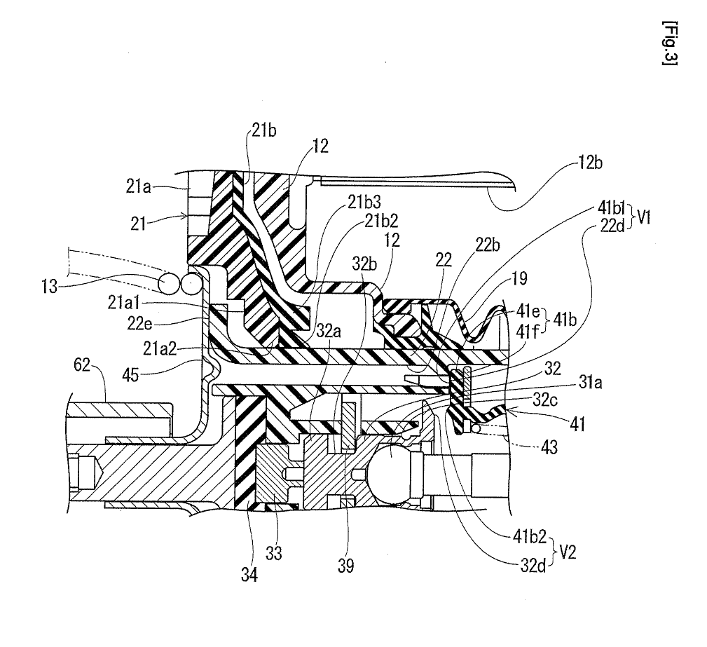

Brake Pedal Sudden Depression State (Sudden Braking Operation: FIG. 3)

When the brake pedal is depressed at a sudden depression speed higher than the normal speed and the valve body 22 moves forward, the input shaft 31 and the plunger 32 move forward from the original position (return position) in FIG. 1 with respect to the valve body 22, the atmospheric valve V2 opens, and the negative-pressure valve V1 closes. At that time, although the pressure in the negative-pressure chamber R1 is originally the negative pressure, the pressure in the negative-pressure chamber R1 increases and approaches the pressure in the variable pressure chamber R2. Meanwhile, this is especially remarkable when the negative pressure in the negative-pressure source is low.

That is, there is a case in which the negative pressure (absolute value) in the negative-pressure chamber R1 is low and the differential pressure between the negative-pressure chamber R1 and the variable pressure chamber R2 is relatively small.

In this case, especially when the braking operation is sudden (at the time of the sudden braking operation), the differential pressure between the negative-pressure chamber R1 and the variable pressure chamber R disappears during the operation, the forward pressing force due to the differential pressure between the negative-pressure chamber R1 and the variable pressure chamber R2 becomes smaller, and the forward movement of the plate 21a, and eventually the valve body 223 is not assisted.

However, immediately after the forward movement of the valve body 22 is started, the pressure in the negative-pressure chamber R1 is sufficiently lower than the pressure in the variable pressure chamber R2, and the differential pressure between the negative-pressure chamber R1 and the variable pressure chamber R2 is relatively large as in the normal depression state, so that the plate 21a is moved forward integrally with the valve body 22. Furthermore, when the pressure in the negative-pressure chamber R1 increases to approach the pressure in the variable pressure chamber R2, the assisting force on the plate 21a decreases, and the valve body 22 moves forward relative to the plate 21a (refer to FIG. 3). In other words, the plate 21a moves rearward relative to the valve body 22. As a result, it is possible to inhibit the pressure in the negative-pressure chamber R1 from increasing to approach the pressure in the variable pressure chamber R2 to be eventually higher than the pressure in the variable pressure chamber R2 due to the integral movement of the plate 21a with the valve body 22 at the time of the sudden depression of the brake pedal (at the time of sudden braking operation).

As is apparent from the description above, the negative-pressure type booster device 1 of this embodiment is the negative-pressure type booster device provided with the hollow housing 10, the movable partition wall 21 formed of the annular plate 21a and the diaphragm 21b to partition the interior of the housing 10 into the front negative-pressure chamber R1 and the rear variable pressure chamber R2, the cylindrical valve body 22 provided so as to be movable forward and rearward relative to the housing 10 and movable forward and rearward relative to the movable partition wall 21 in the housing 10, the plunger 32 (air valve) provided in the shaft hole 22a formed in the valve body 22 and is movable forward and rearward in the axial direction of the shaft hole 22a with respect to the valve body 22 and moves integrally with the input shaft 31, and the valve mechanism V provided with the negative-pressure valve V1 for allowing the negative-pressure chamber R1 to communicate with the variable pressure chamber R2 and blocking the communication in accordance with movement forward and rearward of the plunger 32 with respect to the valve body 22, and the atmospheric valve V2 for allowing the variable pressure chamber R2 to communicate with the atmospheric air and blocking the communication. The valve body 22 is provided with the flange part 22e extending in the radially outward direction from the front part of the valve body 22, the inner peripheral surface of the inner peripheral end on the valve body 22 side of the plate 21a is in sliding contact with the outer peripheral surface of the valve body 22, and the plate 21a is provided with the locking part 21a1 which comes into contact with the flange part 22e so as to restrict the movement in the axially forward direction relative to the valve body 22.

According to this, when the brake operating member (brake pedal) is operated, the input shaft 31 moves forward and the valve body 22 moves forward by the operation, but the plate 21a may move separately from the movement of the valve body 22. That is, the valve body 22 may move forward before the plate 21a moves. As a result, it is possible to inhibit the pressure in the negative-pressure chamber R1 from increasing to approach the pressure in the variable pressure chamber R2 to be eventually higher than the pressure in the variable pressure chamber R2 due to the integral movement of the plate 21a with the valve body 22 at the time of the sudden braking operation. Therefore, it becomes possible to inhibit operation resistance of a driver due to the increase in the pressure in the negative-pressure chamber R1, so that it is possible to improve operation feeling for the driver at the time of sudden braking operation.

Also, the inner peripheral end on the valve body 22 side of the plate 21a is provided with the guide part 21a2 which is in sliding contact with the outer peripheral surface of the valve body 22, extends in the axial direction, and guides the plate 21a in the axial direction relative to the valve body 22. According to this, the guide part 21a2 of the inner peripheral end on the valve body 22 side of the plate 21a guides the plate 21a in the axial direction relative to the valve body 22 while relatively sliding along the outer peripheral surface of the valve body 22. Therefore, it is possible to inhibit the plate 21a from moving while being inclined with respect to the axial direction of the valve body 22.

Also, on the rear surface of the inner peripheral end on the valve body 22 side of the diaphragm 21b, the first stopper 21b3 capable of being in contact with the contacted part (for example, the key member 39) provided on the valve body 22 side is provided. According to this, when the plate 21a moves with delay after the movement of the valve body 22, after the first stopper 21b3 comes into contact with the contacted part (key member 39) on the valve body 22 side, the plate 21a may move forward together with the valve body 22. Therefore, although the operation feeling for the driver is impaired, it is possible to surely boost the brake operating force.

### Second Embodiment

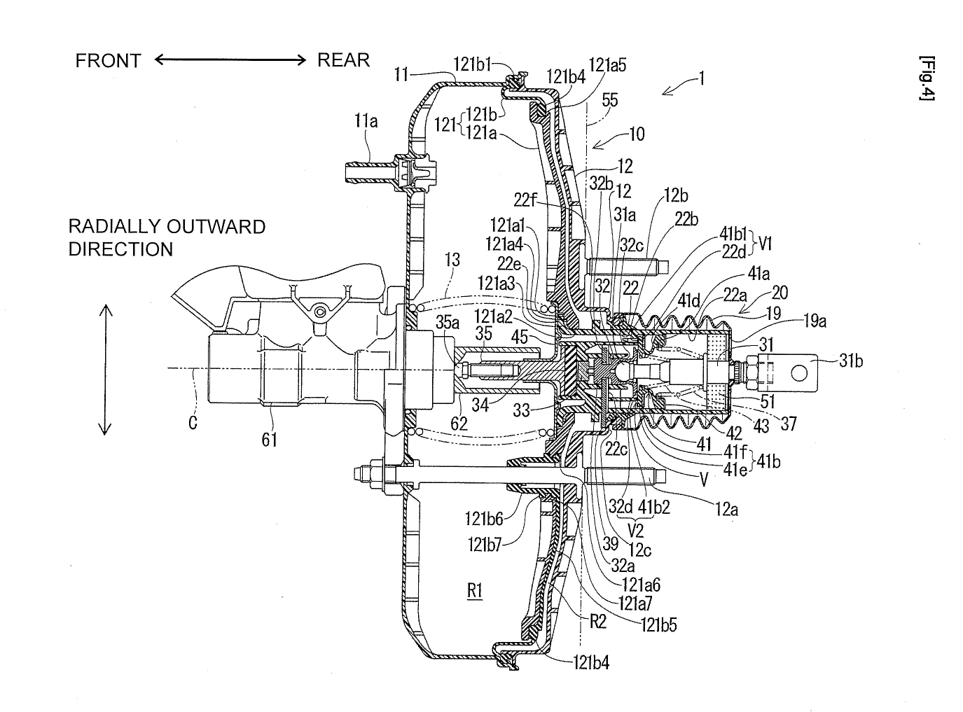

Furthermore, a negative-pressure type booster device according to a second embodiment of the present invention is described with reference to FIG. 4. As illustrated in FIG. 4, a negative-pressure type booster device 1 is different from that of the first embodiment in a configuration of a movable partition wall 121 and the fact that a second stopper 22f is provided. Meanwhile, the same reference sign is given to the same configuration as that of the first embodiment, and the description thereof is not repeated.

The movable partition wall 121 is formed of a plate 121a and a diaphragm 121b. Just like a movable partition wall 21, the movable partition wall 121 partitions the interior of a housing 10 into a front negative-pressure chamber R1 (constant pressure chamber) and a rear variable pressure chamber R2, and is arranged so as to be movable in a front-rear direction (so as to be movable forward and rearward) within the housing 10.

On an inner peripheral end of the plate 121a, a locking part 121a1 is provided just like a locking part 21a1, and a guide part 121a2 is provided just like a guide part 21a2. A seal member 121a3 is provided between a front surface of the inner peripheral end of the plate 121a and a flange part 22e. The seal member 121a3 is fitted to a groove 121a4 provided on the front surface of the inner peripheral end of the plate 121a. An outer peripheral end of the plate 121a is provided with a fitting groove 121a5. In the fitting groove 121a5, an annular inner peripheral bead part 121b4 of the diaphragm 121b is airtightly fitted. The plate 121a is provided with a through hole 121a6 and an engaging part 121a7. In the through hole 121a6, a tie rod seal part 121b6 and an attaching bolt 12a are inserted (penetrated). On an inner peripheral surface of the through hole 121a6, an engaging part 121a7 (convex part) to be engaged with an engaging part 121b7 (concave part) of the diaphragm 121b is provided.

The diaphragm 121b is provided with an outer peripheral bead part 121b1 just like an outer peripheral bead part 21b1. The annular inner peripheral bead part 121b4 is provided on an inner peripheral end of the diaphragm 121b. The inner peripheral bead part 121b4 is provided with a connecting part 121b5 extending in a radially inward direction. The connecting part 121b5 is a belt-shaped member which connects the inner peripheral bead part 121b4 to the tie rod seal part 121b6. The connecting part 121b5 is buried on a rear surface of the diaphragm 121b. A rear surface of the connecting part 121b5 is flush with the rear surface of the diaphragm 121b. The tie rod seal part 121b6 is formed into a cylindrical shape, and the attaching bolt 12a (tie rod bolt) is inserted in the tie rod seal part 121b6 airtightly and slidably. The engaging part 121b7 is provided on an outer peripheral surface of the tie rod seal part 121b6.

The second stopper 22f is provided so as to protrude in a radially outward direction from an outer peripheral surface of the valve body 22. The second stopper 22f may come into contact with at least any one of a rear surface of the plate 121a and the rear surface of the diaphragm 121b. In the second embodiment, the rear surface of the plate 121a may come into contact with the second stopper 22f. Meanwhile, in the above-described first embodiment, the second stopper 22f may be provided. In this case, it is sufficient that the rear surface of the diaphragm 21b (the first stopper 21b3 may come into contact or the rear surface of the diaphragm 21b may come into contact without providing the first stopper 21b3) comes into contact with the second stopper 22f.

In this manner, on the outer peripheral side of the valve body 22, the second stopper 22f which may come into contact with at least any one of the rear surface of the plate 21a and the rear surface of the diaphragm 21b is provided. According to this, when the plate 21a moves with delay after the movement of the valve body 22, after the second stopper 22f comes into contact with at least any one of the rear surface of the plate 21a and the rear surface of the diaphragm 21b, the plate 21a may move forward together with the valve body 22. Therefore, although the operation feeling for the driver is impaired, it is possible to surely boost the brake operating force.

1. A negative-pressure type booster device comprising:
a hollow housing;
a movable partition wall formed of an annular plate and an annular diaphragm for partitioning the interior of the housing into a front negative-pressure chamber and a rear variable pressure chamber;
a cylindrical valve body provided so as to be movable forward and rearward with respect to the housing and provided so as to be movable forward and rearward with respect to the movable partition wall in the housing;
an air valve provided in a shaft hole formed in the valve body and movable forward and rearward in an axial direction of the shaft hole with respect to the valve body and integrally moves with an input member; and
a valve mechanism provided with a negative-pressure valve for allowing the negative-pressure chamber to communicate with the variable pressure chamber and blocking the communication in accordance with the forward and rearward movement of the air valve with respect to the valve body and an atmospheric valve for allowing the variable pressure chamber to communicate with atmospheric air and blocking the communication,
wherein the valve body is provided with a flange part extending in a radially outward direction from a front part of the valve body, and
the annular plate is movable the movement of in an axially rearward direction relative to the valve body in the input member operation state, and is provided with a locking part which comes into contact with the flange part so as to restrict movement in an axially forward direction relative to the valve body in the input member operation state.

2. The negative-pressure type booster device according to claim 1, wherein an inner peripheral end on the valve body side of the plate is provided with a guide part which is in sliding contact with an outer peripheral surface of the valve body, extends in the axial direction, and guides the plate in the axial direction relative to the valve body.

3. The negative-pressure type booster device according to claim 1, wherein a first stopper capable of coming into contact with a contacted part provided on the valve body side is provided on a rear surface of the inner peripheral end on the valve body side of the diaphragm.

4. The negative-pressure type booster device according to claim 1, wherein a second stopper capable of coming into contact with at least any one of a rear surface of the plate and a rear surface of the diaphragm is provided on an outer peripheral side of the valve body.

5. The negative-pressure type booster device according to claim 2, wherein a first stopper capable of coming into contact with a contacted part provided on the valve body side is provided on a rear surface of the inner peripheral end on the valve body side of the diaphragm.

6. The negative-pressure type booster device according to claim 2, wherein a second stopper capable of coming into contact with at least any one of a rear surface of the plate and a rear surface of the diaphragm is provided on an outer peripheral side of the valve body.
